(19) United States
(12) Patent Application Publication
(10) Pub. No.: US 2003/0226142 A1
(43) Pub. Date: Dec. 4, 2003

(54) Apparatus and method for selective insertion and pricing of media data into a media data stream

(76) Inventor: Ricky C. Rand, Foxton Cambridge (GB)

Correspondence Address: Eugene C Rzucidlo, Greenberg Traurig, 885 Third Avenue, New York, NY, 10022, US

(21) Appl. No.: 10/148,292

(22) PCT Filed: Nov. 29, 2000
(86) PCT No.: PCT/US00/32552

(51) Int. Cl. H04N 7/025; H04N 7/10; H04N 7/173

(52) U.S. Cl. 725/32; 725/91

(57) ABSTRACT

A method for a media provider in a media-on-demand network to selectively insert media items into a media stream consists of determining a subscriber's preferences for inserted content, determining suitable positions in the transmitted stream for insertion of other media items, and inserting items into a stream being transmitted to a subscriber. The inserted items can be commercial advertisements from advertisers (170), or other items as selected by either the provider or subscriber, and can be interactive items of indeterminate duration. The media provider utilizes the subscriber's preferences to selectively insert media items into a media stream at the previously determined suitable positions. Advertisers (170) can monitor the delivery frequency of advertisements to subscribers and adjust the price of an ad to change the ad's delivery frequency. The media service provider maintains an ad queue for each user and can order ads in the queue based on the price of each ad.

### CROSS REFERENCE TO RELATED APPLICATIONS

This application claims priority under 35 U.S.C. §119(e) from U.S. Provisional Applications No. 60/167,865, filed Nov. 29, 1999, and No. 60/214,288, filed Jun. 26, 2000, by Rand, et al., which are herein incorporated by reference in their entirety.

### FIELD OF THE INVENTION

This invention is directed to an apparatus and method for selecting media data to be included in a media stream transmitted, e.g., from a video or media service provider to a subscriber. The invention also relates generally to a method for monitoring the frequency of delivery of advertising and providing a plurality of advertisers, who are competing for limited advertising space, from numerous locations, with the ability to monitor and change advertising pricing, which change results in the modification of the priority of advertisements and further results in the re-ordering of advertisements in the advertising queues of a plurality of subscribers.

### BACKGROUND OF THE INVENTION

Recent advances in multi-media computer technology have made possible a variety of new services such as video-on-demand (VOD), or more generally, media-on-demand (MOD). In a MOD service, a subscriber contacts a service provider to request, for example, a movie, and the provider immediately begins transmitting the requested movie to the subscriber. The subscriber has a set-top-box (STB) to communicate with the provider and to control the subscriber's video display monitor.

In the simplest mode of operation, a subscriber contacts the service provider through the STB and selects a single item to watch, after which the MOD provider transmits that selection to the subscriber's STB for viewing. There are, however, many possibilities for more sophisticated modes of providing video or media content to a subscriber. These modes can involve, for example, the mixing of data from different sources into one stream to be delivered to one or more subscribers. Although commercial broadcast and cable television networks routinely mix commercial data with featured data, these networks do not permit customizing the commercial inserts for particular subscribers, nor do they permit subscribers to customize their own data streams. A MOD network additionally provides the subscriber with a communications channel for placing requests to the provider. This communications channel can be utilized to enable a subscriber to specify media items to be inserted, creating a customized media stream.

A MOD service can insert commercial items, such as advertisements, as well as non-commercial items, into a media stream. In the current market, advertisers contract and arrange for space for their advertisements in connection with a particular program and/or time slot. The charge to the advertiser is generally based on the number of predicted viewers of the program and the type of program to be shown. For example, if a program to be shown is about cooking, then it can be assumed that the viewer is interested in cooking and may therefore be interested in buying cookery books or ingredients for a dish, etc. This method of charging is flawed as the number of viewers is only a predicted figure (based on polls of previous shows), and there is very little actual information known about the specific audience of the forthcoming show.

### SUMMARY OF THE INVENTION

The present invention provides advertisers with the ability to monitor the delivery frequency of an advertisement or advertisements and to change the delivery frequency based on an increase or decrease in the advertisement price paid by the advertiser.

It is an object of the present invention to provide advertisers with the ability to modify the frequency of delivery of a particular advertisement or advertisements by changing advertisement price. An increase or decrease in advertisement price results in a change in advertisement priority and a re-ordering of subscribers' advertising queues that contain the advertisement in which the price has been changed. An increase in advertisement price may result in an increase in the delivery frequency of the advertisement. A decrease in the advertisement price may result in a decrease in the frequency of delivery of the advertisement.

It is a further object of them invention to enable advertisers to change the price of their advertisements to compete against each other to obtain preferred delivery rate. This invention provides advertisers with the ability to change the price offered to deliver an advertisement up to the moment that an advertisement is committed for insertion into the media content of a subscriber. As all advertisers will have a similar ability to change the price of their own advertisements, a market is created for advertising space across a population of subscribers. The advertiser is charged only for advertisements that are actually delivered to subscribers, which advertisements are far more targeted due to the advertiser's delivery rules.

It is another object of the present invention to enable the delivery of the same media content to different subscribers with different inserts, and to enable the delivery of the same content to the same subscriber at different times or in different places with different inserts.

The present invention is also directed to the selective insertion of media items into a media data stream provided to an individual viewer or to designated groups of viewers. The media stream can be a video stream, an audio stream, or a combination thereof. The inserted item can also be an interactive application of possibly indeterminate length, a link to a website, a computer generated animation, or a passive item with a hot-button by which a user can request further information.

In one embodiment, the choice of items to be inserted can be made by the service provider. The service provider customizes the insertion based on either preference data provided directly by a subscriber or indirectly based on the subscriber's demographic profile. The invention enables a service provider to selectively insert—advertising, commercial, or other content into a media stream on a subscriber by subscriber basis, region by region basis, or any other basis.

In an alternative embodiment, the invention enables a subscriber to specify a customized data stream by selecting a sequence of media items. This customized media stream can be transmitted by the provider to the subscriber, or can be transmitted to other subscribers in the network.

In a further embodiment, the invention allows a subscriber or provider to build a custom data stream for future delivery to another subscriber. A further feature of the invention is that content for insertion can be selected and inserted while a stream is being transmitted in response to a contemporaneous selection by the subscriber.

### BRIEF DESCRIPTION OF THE DRAWINGS

FIG. 1 is a block diagram of the components of a media provider network implementing the system of the present invention.

FIG. 2 is a schematic diagram of the data stream in a preferred embodiment of the present invention.

### DETAILED DESCRIPTION OF THE INVENTION

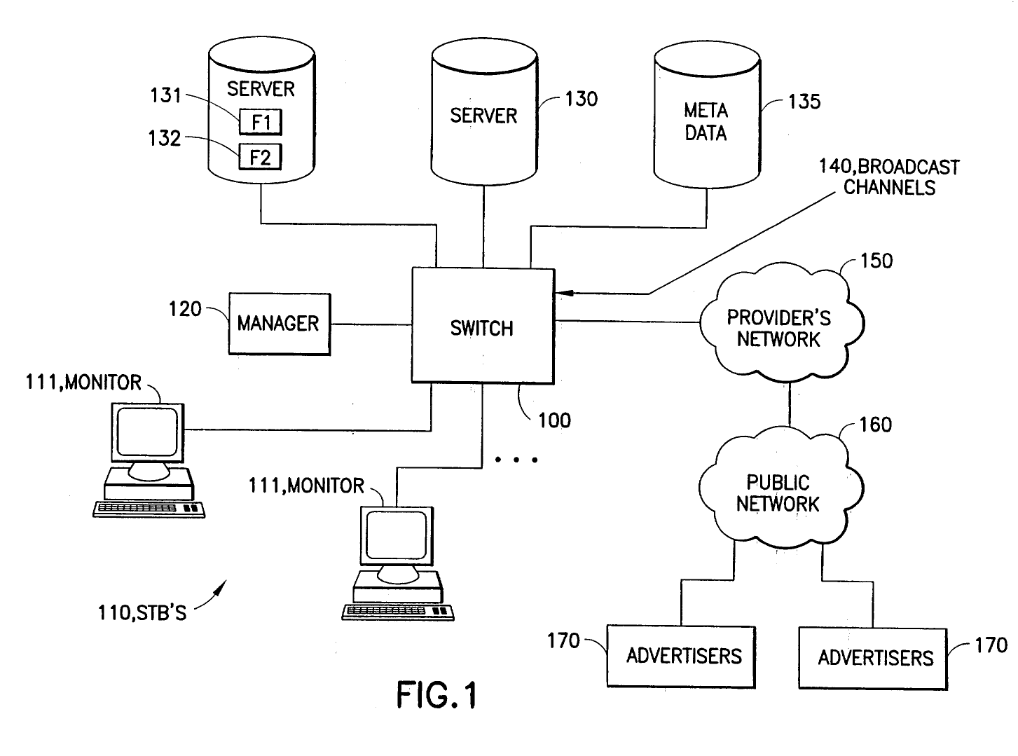

A block diagram of the components of a media provider network implementing a preferred embodiment of the invention is shown in FIG. 1. The media network includes a plurality of interconnected switches 100. Each switch is connected to a manager 120, one or more user set-top-boxes (STBs) 110, one or more servers 130, one or more broadcast channels 140, one or more connections 150 to the provider's network, and at least one connection 155 to a public network 160, such as the Internet or the public telephone network. Each STB 110 is in turn connected to various playback devices, such as a video monitor 111, and various controlling devices (not shown). The servers 130 can be sources for media content, such as movies, music tracks or games, or meta-data that describes the media content and includes suggested insertion points in the content. The provider's network can be of global extent, so that the servers, advertisers, and user subscribers can be anywhere in the world.

The media content can also contain advertisements to be shown to a subscriber by the service provider on behalf of an advertiser. Advertisers 170 wishing to have their advertising content included with the providers media offerings can connect to the provider's network 150 via the public network 160. The service provider determines the selection of and the order of subscriber's advertising inserts to create an advertising queue based upon the delivery rules and advertisement price provided by an advertiser. Becaasue of the global extent of the provider's network, the advertisements available to a subscriber can come from an advertiser anywhere in the world.

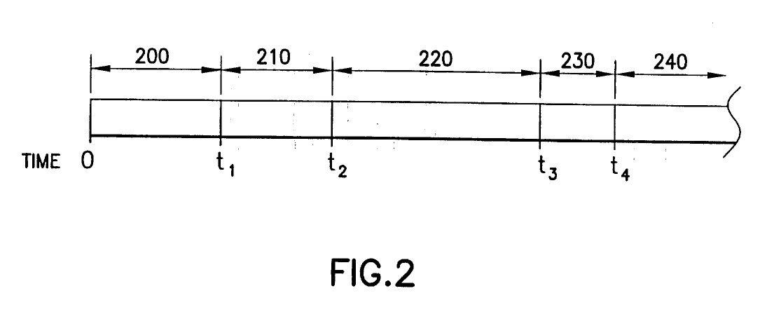

A schematic diagram of a media data stream in a preferred embodiment of the invention is presented in FIG. 2. The data stream begins with data segment 200 at time 0. In an exemplary embodiment of the present invention, segment 200 can be a segment of movie stored in digital video format. At time t1, segment 200 is interrupted by commercial insert 210. The time t1 is chosen by the media provider. Segment 210 terminates at time t2, at which time segment 220 begins transmission. Segment 220 would typically include a resumption of transmission of the movie of segment 200. The transmission of the movie continues until time t3, determined by the provider, at which time the provider begins transmission of another commercial insert 230. Insert segment 230 terminates transmission at time t4, at which time the movie of segment 200 resumes transmission in segment 240. Although this embodiment is presented in terms of one commercial segment per insert, more than one commercial can easily be included in a given insert.

In a preferred embodiment of the invention, the inserted item will not be of predetermined length, but will be an interactive application of possibly indeterminate length. This item could be, for example, a link to a website, a computer generated animation that requests input from the user and performs different actions depending in the user's input, or a passive item with a hot button by which a user can request more information regarding a product or service.

The insertion depicted in FIG. 2 can be performed by the service provider based on a number of factors. These factors can include, for example, content preferences indicated by the subscriber when he or she first contacts the provider, as well as subscriber profiles based on, for example, age, education, and income, and the subscriber's geographic location. A subscriber is identified when he or she logs into the provider's network. The subscriber's demographic profile, which can include age, sex, and viewing history, is made available to the provider and can be used to filter and order content in a queue ready for insertion into a media stream transmitted to the subscriber. Since subscribers can indicate in their preferences how much commercial content they wish to see, and even what kind of products or services they wish to see advertised, the provider can insert as many or as few commercials as desired, and only for those products or services the subscriber wishes to see advertised. Even within the parameters defined by the subscriber, advertising content could be varied by time of day, time of year, and by the subscriber's geographic location to account for those products or services that are locally available or are available only at certain times. If the subscriber has not indicated any advertising content preferences, the server could customize content presented to the subscriber based on the subscriber's demographic profile. Thus, the same content can be delivered to different subscribers with different inserts, and the same content delivered to the same subscriber at different times or in different places can have different inserts.

It is, furthermore, well known that content providers provide meta-data that identifies convenient positioning for commercials within the content. This information has traditionally been used by broadcasters as the preferred locations for their commercials. According to the method of the present invention, however, in the context of VOD or MOD, the meta-data may be analyzed by a computerized process to determine the appropriate location and duration of commercial breaks. Methods for analyzing meta-data are well known in the art and need not be described herein. The methods for analyzing contents preferences or demographic profiles for determining content to be inserted are also well known in the art, and can be used to optimally customize a subscriber's data stream.

Advertisers have access to the provider's network via a public network. An advertisers identifies a target audience and is charged a base price for the delivery of an advertisement. The advertisement price is normally subject to a minimum delivery price, which will be based upon the number and type of delivery rules. Delivery rules can include personal parameters, such as gender, age, geographic location, preferences (e.g. sports, smoking, the color red, etc.), timing parameters such as “at most once per session”, “at least once per hour”, or “exactly once per ad break”, and a variety of other delivery options. Delivery rules of a global nature include rules such as “deliver a total of not more than x per day”, “the promotion runs for a fixed period” or “ends after a total number of deliveries”. Each ad is given a unique id so that the advertiser can follow the demand for that ad at any point in time by accessing the service provider.

The service provider maintains a set of advertising queues and associates an ad queue to each subscriber who is currently accepting ads. Each subscriber's ad queue is filtered in real time according to advertiser delivery rules and the ads within the queue are ordered according to the price of the ads in the resulting queue. In one preferred embodiment of the invention, the subscriber subscribes to an advertisement supported subscription package and advertisements are automatically inserted into the media stream delivered to the subscriber.

When an advertiser reserves an advertisement on one of the provider's servers, a record is created in a database of ads. Each ad record includes information such as an advertiser code, a unique for each ad, the price, the delivery rules, and a universal resource name (URN) that identifies the media object, for example, an encoded video of the ad, to be inserted.

An advertiser can access the provider's network at any time to monitor the current delivery frequency of a particular ad. The advertiser can use the advertiser code and the unique ad id to monitor the current demand for an ad or the predicted frequency of delivery based on the position of the advertisement in the advertising queues of all subscribers that contain it and the rate at which advertisements are expected to be shown to subscribers (and hence removed from their advertising queues). The delivery frequency can be monitored for a number of different time frames including deliveries per minute, per hour, and per day. This is useful in comparing the predicted delivery rate of an ad over some period, such as a day, when the price is varied up and down. The advertiser may increase or decrease the price paid for an advertisement or advertisements. The demand can be expressed in terms of deliveries per minute or some other suitable format. If the advertiser wished to increase-demand for its ad, it could increase the price, or if the advertiser wishes to minimize expenditures, it could decrease the price. These price changes can be done on a “what if” basis to evaluate hypothetical changes in prices and confirmed once a satisfactory balance of price and delivery rate is achieved.

Advertisers can be charges a transaction fee for evaluating and/or making price changes. When an ad is delivered, a transaction record is created and the advertisers account is debited. Optionally, the subscribers' account can be credited as a result of the delivery of the ad. An advertiser periodically receives from the service provider a transaction report detailing the delivery frequency and price charges per delivery for its ads shown to subscribers.

The service provider can analyze the delivery frequencies of ads in a subscriber's ad queue based on a number of conditions, including after an ad has been delivered, upon changing the price of an ad in the queue, and on a periodic basis.

In an alternative preferred embodiment, segments 200, 210, 220, 230, and 240 in FIG. 2 can be distinct media data items pre-selected by the subscriber. These media items can be selected from any type of media maintained by the server, such as, for example, video data or audio data. Depending on preferences entered by the subscriber, the provider can insert commercial material into this customized stream, as previously described.

A subscriber or provider can also specify a customized stream for future delivery. For example, a provider's server can create an anthology of the best sequences of a particular television series with a new soundtrack. This anthology can be created either by the provider on its own initiative, or in response to a subscriber request. Rather than duplicating those parts of the anthology that are copied, the system of the invention will store pointers to the inserted segments in a permanent storage device, along with the new sound track. These pointers will be resolved at run-time, after a subscriber has requested delivery of the anthology. The subscriber can also specify that the customized data stream be delivered to a subscriber other than the requesting subscriber. The customization of a data stream can also be performed dynamically. For example, a movie with multiple endings can prompt the subscriber to make a selection during the delivery of the movie. The subscriber's selection will determine which segment the server will subsequently deliver to the subscriber.

Referring back to FIG. 1, server 130 can contain a library of digitized movies, of which two, F1 131 and F2 132, are depicted for illustrative purposes. An STB 110 queries manager 120 for content F1 131, after which manager 120 instructs video server 130 to stream F1 131 to STB 110. Manager 120 then checks meta-data 135 to find an insert point in F1 131. Meta-data 135 can be, for example, a library or database of suitable insertion locations for each item contained on server 130. Once the insertion point is found, manager 120 instructs video server 130 to halt delivery of content F1 131 and send content F2 132 to STB 110. After content F2 132 has been sent, manager 120 instructs server 130 to resume delivery of content F1 131.

Alternatively, content F1 131 can be a movie with a different ending F2 132. At some time during the delivery of F1 131 to STB 110, the subscriber will be prompted to make a choice. This choice will be transmitted to manager 120, which will then instruct server 130 whether to continue the delivery of content F1 131 or start delivery of content F2 132 instead.

In a third alternative, STB 110 may request that manager 120 send content F1 131 followed by content F2 132. Manager 120 will then instruct server 130 to send the requested content to STB 110.

The embodiment described here is for illustrative purposes only, and the invention is in no way limited to the embodiment described above. It is evident that numerous alternative modifications, variations, and uses will be apparent to those skilled in the art in light of the foregoing disclosure.

What is claimed is:

1. An apparatus for selective insertion of media items into a media stream to be transmitted over a media-on-demand network connecting a service provider to one or more subscribers, said apparatus comprising:
means for a service provider to obtain from a subscriber preferences regarding amount and content of media items to be inserted into a media stream;
means for the determining positions in the media stream where said items may be inserted; and
means for selectively inserting said media items into a media stream to be transmitted by the service provider;
whereby the service provider utilizes the subscriber's preferences to selectively insert media items into the media stream being transmitted from the service provider to the subscriber, at positions in the media stream determined by the position determination means.

2. The apparatus of claim 1, wherein the means for obtaining the subscriber's preferences is a data entry screen presented to and operated by the subscriber.

3. The apparatus of claim 1, wherein the means for determining insertion positions in a media stream is a metadata file associated with the media stream.

4. The apparatus of claim 1, wherein the means for inserting media items into a media stream is a computer program adapted to control the server.

5. The apparatus of claim 1, further comprising means for obtaining a subscriber's demographic profile; and means for analyzing the subscriber's demographic profile to determine the subscriber's preferences regarding amount and content of items to be inserted into the media stream.

6. The apparatus of claim 1, further comprising means for the subscriber to specify a media stream from a successive insertion of media items, the media stream to be transmitted by the service provider to the subscriber.

7. The apparatus of claim 6, further comprising means for the service provider to transmit the subscriber specified media stream to additional subscribers on the network.

8. The apparatus of claim 1, further comprising means for the provider to construct a media stream from a successive insertion of media items.

9. The apparatus of claim 1, further comprising means for dynamically inserting a media item into a stream being transmitted to a subscriber based on the subscriber's response to a query.

10. An apparatus for selective insertion of media items into a media stream to be transmitted over a media-on-demand network connecting a service provider to one or more subscribers, comprising:
means for a service provider to obtain from a subscriber preferences regarding amount and content of media items to be inserted into a media stream;
means for obtaining a subscriber's demographic profile;
means for analyzing the subscriber's demographic profile to determine the subscriber's preferences regarding amount and content of items to be inserted into the media stream;
means for determining positions in the media stream where items may be inserted; and
means for selectively inserting media items into a media stream to be transmitted by the service provider;
whereby the service provider utilizes the subscriber's preferences to selectively insert media items into the media stream being transmitted from the service provider to the subscriber, at positions in the media stream determined by the position determination means;

11. The apparatus of claim 10, further comprising:
means for the subscriber to specify the construction of a custom media stream from a successive insertion of media items; and
means for the service provider to construct a custom media stream from a successive insertion of media items;
whereby the customized media streams can transmitted to any subscriber.

12. The apparatus of claim 10, further comprising means for the service provider to dynamically inserting a media item into a stream being transmitted to a subscriber based on the subscriber's response to a query.

13. A method for selectively inserting media items into a media stream transmitted from a service provider to a subscriber in a media-on-demand network, comprising the steps of:
obtaining a subscriber's preferences regarding amount and content of media items to be inserted into the media stream;
determining positions in the media stream where media items may be inserted; and
selectively inserting media items into a media stream to be transmitted by the service provider to the subscriber.

14. The method of claim 13, further comprising the steps of the service provider obtaining a subscriber's demographic profile and analyzing said demographic profile to determine the subscriber's preferences regarding amount and content of items to be inserted.

15. The method of claim 13, wherein a subscriber specifies to a service provider a successive insertion of media-items into a media stream, which media stream is to be transmitted by the service provider to the subscriber.

16. The method of claim 15, wherein the service provider transmits the subscriber specified media stream to additional subscribers on the network.

17. The method of claim 13, wherein a service provider constructs a media stream from a successive insertion of media items.

18. The method of claim 13, wherein a service provider dynamically inserts a media item into a media stream being transmitted to a subscriber based on said subscriber's response to a query.

19. A method for pricing advertising in a media-on-demand network, said method comprising the steps of:
delivering by a media-on-demand service provider one or more advertisements provided by an advertiser to a subscriber as part of a media stream delivered to said subscriber;
monitoring by the service provider the delivery frequency of the one or more advertisements delivered to said user;
storing said one or more delivery frequencies in a database maintained by the service provider;
accessing the advertisement delivery frequency database by the advertiser;
changing an advertisement price by the individual advertiser to alter the advertisement delivery frequency;
comparing the modified advertisement prices of the individual advertisements; and
ordering the one or more advertisements to be delivered to the subscriber based upon the highest advertisement price.

20. The method of claim 19, further comprising the steps of:
subjecting each advertisement to a minimum delivery price based on one or more delivery rules, wherein said one or more delivery rules characterize the preferred subscriber to whom the advertisement is to be delivered and the frequency of delivery.

21. The method of claim 20, further comprising the steps of:
when an advertiser reserves the one or more advertisements with the media service provider, creating a record in a database of advertisements and assigning an advertisement code, a unique identifier code, a price, one or more delivery rules, and a universal resource name of a media item assisted with said advertisement,
wherein the advertiser utilizes the advertiser code and unique identifier code to monitor the delivery frequency of a particular advertisement.

22. The method of claim 19, further comprising the step of maintaining an advertising queue for each subscriber accepting advertisements to hold the ordered one or more advertisements to be delivered to said subscriber.

23. The method of claim 19, further comprising the step of charging a transaction fee when the advertiser evaluates the delivery frequency of one of the one or more advertisements.

24. The method of claim 19, further comprising the step of charging to the advertiser when the advertiser changes the price of one of the one or more advertisements.

25. The method of either claim 23 or 24 wherein the transaction fee is charged to the advertiser.

26. The method of either claim 23 or 24 wherein the transaction fee is debited to the subscriber.

27. The method of claim 19, further comprising the step of the service provider providing the advertiser with a report detailing the delivery frequency and price charges per delivery for the one or more advertisements delivered to subscribers.
